(19) United States
(12) Patent Application Publication
(10) Pub. No.: US 2012/0092347 A1
(43) Pub. Date: Apr. 19, 2012

(54) ELECTRONIC DEVICE AND METHOD FOR DISPLAYING WEATHER INFORMATION THEREON

(75) Inventor: YI-CHANG DU, Taoyuan (TW)

(73) Assignee: FOXCONN COMMUNICATION TECHNOLOGY CORP., Taoyuan County (TW)

(21) Appl. No.: 12/960,469

(22) Filed: Dec. 4, 2010

(30) Foreign Application Priority Data
Oct. 18, 2010 (TW) 99135453

(51) Int. Cl. G06T 13/00; H04B 7/00

(52) U.S. Cl. 345/473; 370/310

(57) ABSTRACT

An electronic device and method displays weather information by different location images processed using image effects. A location of the electronic device is detected then the electronic device receives weather information of the location from a server. Upon detecting that the weather information, the electronic device reads the image effects of the images from a storage unit. After the electronic device reads the images from the server according to the location information. The images processed using the image effects are then displayed on a display unit of the electronic device.

### BACKGROUND

1. Technical Field

Embodiments of the present disclosure relate to automatic presentation of information, and more particularly to a method for displaying weather information on an electronic device and the electronic device thereof.

2. Description of Related Art

A common technique for displaying weather information in an electronic device is to input a predefined location and access corresponding weather databases using the Internet. The weather information is provided as text information or with a predefined image corresponding to the weather information received. However, the information or the image provides no variability. Further, it is necessary to input or search the predefined location to check the weather information again manually.

### BRIEF DESCRIPTION OF THE DRAWINGS

FIG. 1 is a block diagram of one embodiment of an electronic device.

FIG. 2 is a flowchart of one embodiment of a method for displaying weather information using an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module or may be stored in any type of computer-readable medium or other computer storage device.

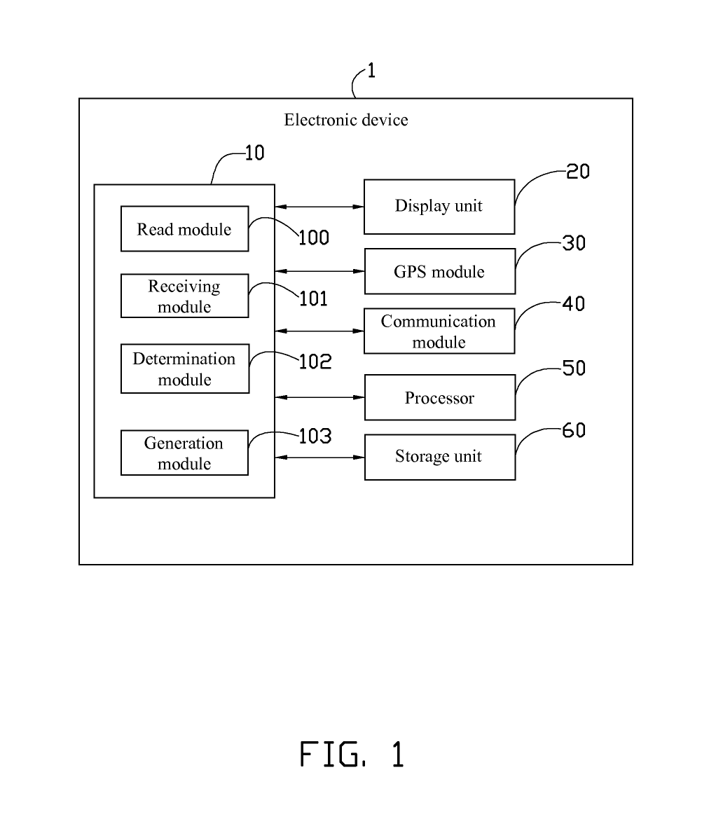

FIG. 1 is a block diagram of one embodiment of an electronic device 1. Depending on the embodiment, the electronic device 1 may be a mobile phone, a personal digital assistant (PDA), a handheld game console, a digital camera (DC), a handheld computer, or other device. The electronic device 1 includes a system 10, a display unit 20, a GPS module 30, a communication module 40, at least one processor 50, a storage unit 60, and one or more programs including a read module 100, a receiving module 101, a determination module 102, and a generation module 103. The system 10 can communicate with a server to access weather information by the communication module 40 and save the weather information in the storage unit 60.

The electronic device 1 is generally controlled and coordinated by an operating system software, such as UNIX, LINUX, WINDOWS, MAC OS X, an embedded operating system, or any other compatible operating systems. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

The display unit 20 displays images related to the provided weather information. The display unit 20 can be a display screen, a resistive touch screen, or a capacitive touch screen.

The GPS module 30 is operable to detect a current location of the electronic device 1. The GPS module 30 can calculate a current location of the electronic device 1 based on latitude, longitude, and altitude by trigonometric measurement of accurate time and distance from three or more satellites using three different distance values. The GPS module 30 obtains time and distance information from 3 satellites and corrects an error with one satellite, and provides the calculated location information to the processor 50 which reads the corresponding geographic information from a map database accordingly. The map database can be stored in the storage unit 60 or using an Internet server.

The communication module 40 is operable to communicate with a server wirelessly. In one embodiment, the communication module 40 may transfer the weather information and the images from the server to the electronic device 1 by Third Generation network (3G) or WIFI network though a 3G module or a Wi-Fi module.

The modules 100-103 may comprise computerized code in the form of one or more programs that are stored in the storage unit 60. The computerized code includes instructions that are executed by the at least one processor 50 to provide functions for modules 100-103. The at least one processor 50, as an example, may include a CPU, math coprocessor, shift register, for example.

The storage unit 60 is electronically connected to the display unit 20, the GPS module 30, the communication module 40, the at least one processor 50, the read module 100, the receiving module 101, the determination module 102 and the generation module 103. The storage unit 60 is operable to store many kinds of data, such as images, image effects, the location information of the electronic device 1 and the weather information. The storage unit 60 further stores computerized codes of the system 10, programs of an operating system and other applications of the electronic device 1. The storage unit 60 may include a hard disk drive, flash memory, RAM, ROM, cache, or external storage mediums. The image effects are animated effects related to the weather information. Further details are disclosed below.

The read module 100 is operable to read the image effects and images from the storage unit 60. For example, the images may be images of streets, buildings or travel sites. In one embodiment, the read module 100 reads the images according to the location information received from the GPS module 30. The read module 100 further can read the images and the image effects from the server by the communication module 40. In other embodiments, the image effects may be a rain drops effect, a sunny effect, a cloudy effect or a snowy effect. For example, the sunny effect can be an animation of the sun and sun rays. The rain drops effect can be the animation of rainy drops in a rainy day. The cloudy effect can be the animation of moving clouds in the sky. The snowy effect can be the animation of a number of falling snows.

The receiving module 101 is operable to receive the location information of the electronic device 1 detected from the GPS module 30. Furthermore, the receiving module 101 is also operable to receive the weather information from the server according to the location information of the electronic device 1.

The determination module 102 is operable to determine the image effects according to the weather information. For example, if the weather information received from the server is that a defined day will be raining, then the image effects can be the animation of rain drops (“rain drops effect”). In one embodiment, the determination module 102 determines the images effects from the storage unit 60 according to the weather information. In other embodiments, the determination module 102 determines the image effects from the server using the Internet.

The generation module 103 is operable to execute an image processing method on the images using the image effects. In one embodiment, the receiving module 101 receives the location information from the GPS module 30, and then receives the weather information from the server according to the location information. The read module 100 reads a street image according to the location to the generation module 103. The street image is a surrounding image of a street. In addition, the read module 100 reads a rain drops effect from the server or the storage unit 60 according to the weather information to the generation module 103. The generation module 103 then combines the rain drops effect into the street image to form a composite image.

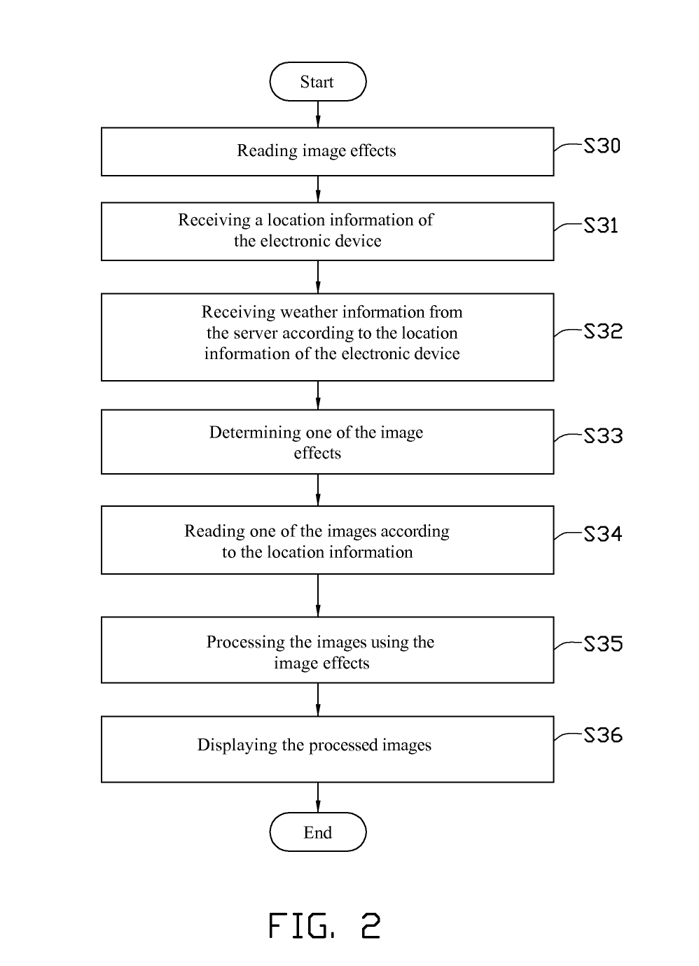

FIG. 2 is a flowchart of one embodiment of a method for displaying weather information using an electronic device 1. Depending on the embodiment, additional blocks may be added, others deleted, and the ordering of the blocks may be changed.

In block S30, the read module 100 reads the image effects from the storage unit 60. In one embodiment, the image effects may be a rain drops effect, a sunny effect, a cloudy effect, or a snowy effect. In other embodiments, the read module 100 can read the image effects from a server though a wireless communication. The wireless communication can be Third Generation (3G) network or WIFI network.

In block S31, the receiving module 101 receives the location information of the electronic device 1 detected from the GPS module 30.

In block S32, the receiving module 101 receives the weather information from the server according to the location information of the electronic device 1 by the communication module 40. For example, the receiving module 101 can receive the weather information of a rainy day, a sunny day, a cloudy day or a snowy day from the server according to the location information of the electronic device 1.

In block S33, the determination module 102 determines the image effects according to the weather information received form the server. For example, if the weather information received from the server is for a sunny day, the determination module 102 determines the sunny effect to execute an image processing on the images. For example, the images can include images of streets, buildings or travel sites. In addition, the images can be received from the server or the storage unit 60.

In block S34, the receiving module 101 reads the images from the server though a wireless communication or from the storage unit 60 according to the location information of the electronic device 1.

In block S35, the generation module 103 executes the image processing on the images using the image effects. In one embodiment, according to the location information of the electronic device 1, the read module 100 reads a street image from the server or the storage unit 60. Furthermore, the read module 100 reads a rain drops effect from the server or the storage unit 60 according to the weather information. The generation module 103 then executes the street image using the rain drops effect. For example, the rain drops effect can be the animation of rainy drops in the rainy day.

In block S36, the display unit 20 displays the images processed by the generation module 103. For example, the display unit 20 can display the street image processed using the rain drops effect to show the weather information of a rainy day in the street.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a display unit;
a GPS module operable to generate a location information of the electronic device according to a location of the electronic device;
a communication module operable to communicate with a server though a wireless communication medium;
at least one processor;
a storage unit operable to save images, image effects of the images, the location information of the electronic device and a weather information of the location;
one or more programs that are stored in the storage unit and are executed by the at least one processor, the one or more programs comprising:
a read module operable to read the images and the image effects from the storage unit;
a receiving module operable to receive the weather information of the location from the server according to the location information of the electronic device detected from the GPS module;
a determination module operable to determine image effects according to the weather information of the location received; and
an generation module operable to execute an image processing method on the images using the image effects.

2. The electronic device of claim 1, wherein the read module further reads the images from the server using the Internet.

3. The electronic device of claim 1, wherein the images include images of streets, buildings, or travel sites.

4. The electronic device of claim 1, wherein the image effects are a rain drops effect, a sunny effect, a cloudy effect, and a snowy effect.

5. The electronic device of claim 1, wherein the receiving module further saves the weather information of the location received from the server in the storage unit.

6. The electronic device of claim 1, wherein the communication module is a Third Generation module, or a WIFI module.

7. The electronic device of claim 1, wherein the display unit displays the images and the image effects of the images.

8. A method for displaying a weather information of a location using an electronic device in communication with a server, the electronic device comprising a storage unit, a display unit and a GPS module, the method comprising:
reading image effects of images from the storage unit;
receiving a location information of the electronic device detected from the GPS module;
receiving the weather information of the location from the server according to the location information of the electronic device;
determining the image effects of the images according to the weather information of the location received;
reading the images from the server though a wireless communication according to the location information of the electronic device;
executing an image processing method on the images using the image effects of the images; and
displaying the processed images on the display unit.

9. The method of claim 8, further comprising saving the weather information of the location in the storage unit.

10. The method of claim 8, further comprising saving the image effects of the images in the storage unit.

11. The method of claim 8, wherein the images include images of streets, buildings and travel sites.

12. The method of claim 8, wherein the image effects are a rain drops effect, a sunny effect, a cloudy effect and a snowy effect.

13. A storage medium having stored thereon instructions that, when executed by a processor, causes the processor to perform a method for displaying a weather information of a location using an electronic device in communication with a server, the electronic device comprising a storage unit, a display unit and a GPS module, the method comprising:
reading image effects of images from the storage unit;
receiving a location information of the electronic device detected from the GPS module;
receiving the weather information of the location from the server according to the location information of the electronic device;
determining the image effects of the images according to the weather information of the location received;
reading the images from the server though a wireless communication according to the location information of the electronic device;
executing an image processing method on the images using the image effects of the images; and
displaying the processed images on the display unit.

14. The storage medium of claim 13, wherein the method further comprising saving the weather information of the location in the storage unit.

15. The storage medium of claim 13, wherein the method further comprising saving the image effects of the images in the storage unit.

16. The storage medium of claim 13, wherein the images include images of streets, buildings and travel sites.

17. The storage medium of claim 13, wherein the image effects are a rain drops effect, a sunny effect, a cloudy effect and a snowy effect.
